(19) United States
(12) Patent Application Publication
(10) Pub. No.: US 2015/0120296 A1
(43) Pub. Date: Apr. 30, 2015

(54) SYSTEM AND METHOD FOR SELECTING NETWORK-BASED VERSUS EMBEDDED SPEECH PROCESSING

(71) Applicant: AT&T Intellectual Property I, L.P., Atlanta, GA (US)

(72) Inventors: Benjamin J. STERN, Morris Township, NJ (US); Enrico Luigi BOCCHIERI, Chatham, NJ (US); Diamantino Antonio CASEIRO, Philadelphia, PA (US); Danilo GIULIANELLI, Whippany, NJ (US); Ladan GOLIPOUR, Morristown, NJ (US)

(73) Assignee: AT&T Intellectual Property I, L.P., Atlanta, GA (US)

(21) Appl. No.: 14/066,105

(22) Filed: Oct. 29, 2013

(51) Int. Cl. G10L 25/48; G10L 25/03

(52) U.S. Cl. CPC G10L 25/48; G10L 25/03
USPC 704/236

(57) ABSTRACT

Disclosed herein are systems, methods, and computer-readable storage media for making a multi-factor decision whether to process speech or language requests via a network-based speech processor or a local speech processor. An example local device configured to practice the method, having a local speech processor, and having access to a remote speech processor, receives a request to process speech. The local device can analyze multi-vector context data associated with the request to identify one of the local speech processor and the remote speech processor as an optimal speech processor. Then the local device can process the speech, in response to the request, using the optimal speech processor. If the optimal speech processor is local, then the local device processes the speech. If the optimal speech processor is remote, the local device passes the request and any supporting data to the remote speech processor and waits for a result.

### BACKGROUND

1. Technical Field

The present disclosure relates to speech processing and more specifically to deciding an optimal location to perform speech processing.

2. Introduction

Automatic speech recognition (ASR) and speech and natural language understanding is an important input modality for dominant and emerging segments of the technology marketplace, including smartphones, tablets, in-car infotainment systems, digital home automation, and so on. Speech processing can also include speech recognition, speech synthesis, natural language understanding with or without actual spoken speech, dialog management, and so forth. Often a client device can perform speech processing locally, but with various limitations, such as reduced accuracy or functionality. Further, client devices often have very limited storage, so that only a certain number of models can be stored on the client device at any given time.

A network based speech processor can apply more resources to a speech processing task, but introduces other types of problems, such as network latency. A client device can take advantage of a network based speech processor by sending speech processing requests over a network to speech processing engine running on servers in the network. Both local and network based speech processing have various benefits and detriments. For example, local speech processing can operate when a network connection is poor or nonexistent, and can operate with reliably low latency independent of the quality of the network connection. This mix of features can be ideal for quick reaction to command and control input, for example. Network based speech processing can support better accuracy by dedicating more compute resources than are available on the client device. Further, network based speech processors can take advantage of more frequent technology updates, such as updated speech models or speech engines.

Some product categories can use both local and network based speech processing for different parts of their solution, such as an in-car speech interface, but often follow rigid rules that do not take in to account the various performance characteristics of local or network based speech processing. An incorrect choice of a local speech processor can lead to poorer than expected recognition quality, while an incorrect choice of a network based speech processor can lead to a greater than expected latency.

### BRIEF DESCRIPTION OF THE DRAWINGS

FIG. 1 illustrates an example speech processing architecture including a local device and a remote speech processor;

FIG. 2 illustrates some components of an example local device;

FIG. 3 illustrates an example method embodiment; and

FIG. 4 illustrates an example system embodiment.

### DETAILED DESCRIPTION

This disclosure presents several ways to avoid high latency or poor quality associated with selecting a sub-optimal location to perform speech processing in an environment where both local and network based speech processing solutions are available. Example systems, methods, and computer-readable media are disclosed for hybrid speech processing, that determine which location for speech processing is “optimal” on a request-by-request basis, based on one or more contextual factors. The hybrid speech processing system can determine optimality for performing speech processing locally or in the network based on pre-determined rules or machine learning.

A hybrid speech processing system can select between local and network based speech processing by combining and analyzing a set of contextual factors as each speech recognition request is made. The system can combine and weight these factors using rules and/or machine learning. The choice of which specific factors to consider and the weights assigned to those factors can be based on a type of utterance, a context of the local device, user preferences, and so forth. The system can consider factors such as wireless network signal strength, task domain (such as messaging, calendar, device commands, or dictation), grammar size, dialogue context (such as whether this is an error recovery input, or a number of turns in the current dialog), recent network latencies, the source of such network latencies (whether the latency is attributable to the speech processor or to network conditions, and whether those network conditions causing the increased latency are still in effect), recent embedded success/error rates (can be measured based on how often a user cancels a result, how often the user must repeat commands, whether the user gives up and switches to text input, and so forth), a particular language model being used or loaded for use, a security level for a speech processing request (such as recognizing a password), whether newer speech models are available in the network as opposed to on the local device, geographic location, loaded application or media content on the local device, usage patterns of the user, partial results, and partial confidence scores of an in-progress speech recognition, and so forth.

The system can combine all or some of these factors based on rules or based on machine learning that can be trained with metrics such as success or duration of interactions. Alternatively the system can route speech processing tasks based on a combination of rules and machine learning. For example, machine learning can provide a default behavior set to determine where is ‘optimal’ to perform speech processing tasks, but a rule or a direct request from a calling application can override that determination.

The hybrid speech processing system can apply to automatic speech recognition (ASR), language understanding (NLU) of textual input, machine translation (MT) of text or spoken input, text-to-speech synthesis (TTS), or other speech processing tasks. Different speech and language technologies can rely on different types of factors and apply different weights to those factors. For example, factors for TTS can include the content of text phrase to be spoken, or whether the local voice model contains the best-available units for speaking the text phrase, while a factor for NLU can be available vocabulary models on the local device and the network speech processor.

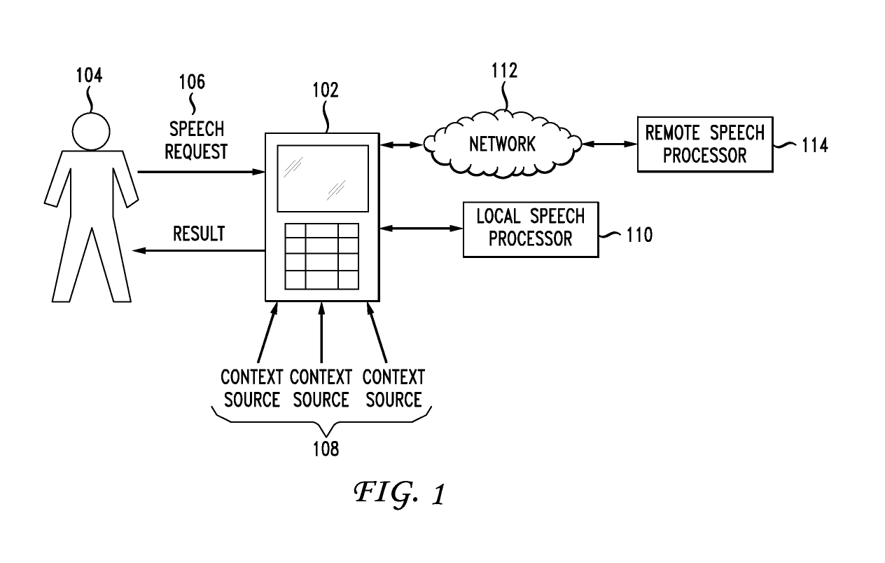

FIG. 1 illustrates an example speech processing architecture 100 including a local device 102 and a remote speech processor 114. A user 104 or an application submits a speech processing request 106 to the device 102. The speech processing request can be a voice command, a request to translate speech or text, an application requesting text-to-speech services, etc. The device 102 receives information from multiple context sources 108 to decide where to handle the speech processing request. In one variation, the device 102 receives the speech processing request 106 and polls context sources 108 for context data upon which to base a decision. In another variation, the device 102 continuously monitors or receives context data so that the context data is always ready for incoming speech processing requests. Based on the context data 108 and optionally on the type or content of the speech processing request, the device 102 either routes the speech processing request to the local speech processing 110 or to the remote speech processor 114 over a network 112, or to both. Upon receiving output from the selected speech processor, the device 102 returns the result to the user 104, the requesting application on the device 102, or to a target indicated by the request.

While FIG. 1 illustrates a single remote speech processor 114, the device 102 can interact with multiple remote speech processors with different performance and/or network characteristics. The device 102 can decide, on a per-request basis, between a local speech processor and one or more remote speech processors. For example, competing speech processing vendors can provide their own remote speech processors at different price points, tuned for different performance characteristics, or with different speech processing models or engines. In another example, a single speech processing vendor provides a main remote speech processor and a backup remote speech processor. If the main remote speech processor is unavailable, then the device 102 may make a different decision based on performance changes between the main remote speech processor and the backup remote speech processor.

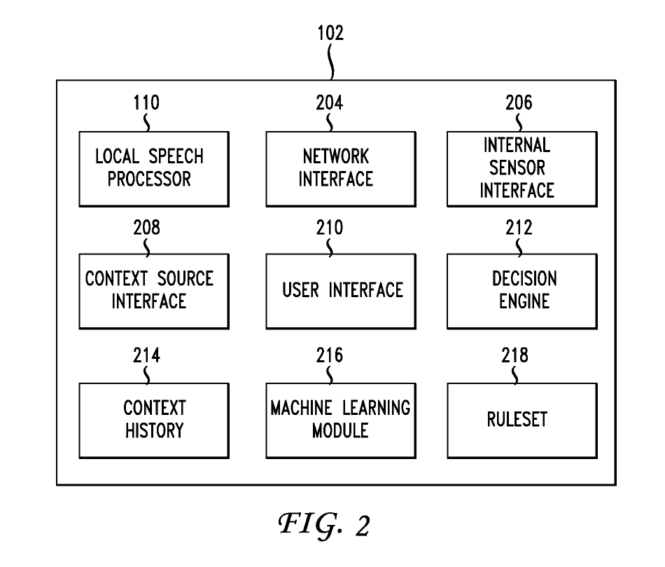

FIG. 2 illustrates some components of an example local device 102. This example device 102 contains the local speech processor 110 which can be a software package, firmware, and/or hardware module. The example device 102 can include a network interface 204 for communicating with the remote speech processor 114. The device 102 can receive context information from multiple sources, such as from internal sensors such as a microphone, accelerometer, compass, GPS device, Hall effect sensors, or other sensors via an internal sensor interface 206. The device 102 can also receive context information from external sources via a context source interface 208 which can be shared with or part of the network interface 204. The device 102 can receive context information from the remote speech processor 114 via the network interface 204, such as available speech models and engines, versions of the speech models and engines, current workload on the remote speech processor 114, and so forth. The device 102 can also receive context information directly from the network interface itself, such as network conditions, availability of a Wi-Fi connection versus a cellular connection, availability of a 3G connection versus a 4G connection, and so forth. The device 102 can receive certain portions of context via the user interface 210 of the device, either explicitly or as part of input not directly intended to provide context information. The application can also be a source of context information. For example, the application can provide information about how important the interaction is, the current position in a dialog (informational, vs. confirmation vs. error recovery), and so forth.

The decision engine 212 receives the speech request 106, and determines which pieces of context data are relevant to the speech request 106. The decision engine 212 combines and weights the relevant pieces of context data, and outputs a decision or command to route the speech request 106 to the local speech processor 110 or the remote speech processor 114. The decision engine 212 can also incorporate context history 214 in the decision making process. The context history 214 can track not only the context data itself, but also speech processing decisions made by the decision engine 212 based on the context data. The decision engine 212 can then re-use previously made decisions if the current context data is within a similarity threshold of context data upon which a previously made decision was based. A machine learning module 216 can track the output of the decision engine 212 with reactions of the user to determine whether the output was correct. For example, if the decision engine 212 decides to use the local speech processor 110, but the user 104 has difficulty understanding the result and repeats the request multiple times before progressing in the dialog, then the machine learning module 118 can provide feedback that the output of the local speech processor 110 was not accurate enough. This feedback can prompt the decision engine 212 to adjust the weights of one or more context factors, or which context factors to consider. Alternatively, when the feedback indicates that the decision was correct, the machine learning module 118 can reinforce the selection of context factors and their corresponding weights.

The device 102 can also include a rule set 218 of rules that are generally applicable or specific to a particular user, speech request type, or application, for example. The rule set 218 can override the outcome of the decision engine 212 after a decision has been made, or can preempt the decision engine 212 when a particular set of circumstances applies, effectively stepping in to force a specific decision before the decision engine 212 begins processing. The rule set 218 can be separate from the decision engine 212 or incorporated as a part of the decision engine 212. One example of a rule is routing speech searches of a local database of music to a local speech processor when a tuned speech recognition model is available. The device may have a specifically tuned speech recognition model for the artists, albums, and song titles stored on the device. Further, a 2-3 second speech recognition delay may annoy the user, especially in a multi-level menu navigation structure. Another example of a rule is routing speech searches of contacts to a local speech processor when a grammar of contact names is up-to-date. If the grammar of contact names is not up-to-date, then the rule set can allow the decision engine to make the best determination of which speech processor is optimal for the request. A grammar of contact names can be based on a local address book of contacts, whereas a grammar at the remote speech processor can include thousands or millions of names, including ones outside of the address book of the local device.

The device makes a separate decision for each speech request whether to service the speech request via the local speech processor or the remote speech processor. In another variation, the device determines a context granularity in which some core set of context information remains unchanged. All incoming speech requests of a same type for that period of time in which the core set of context information remains unchanged are routed to the same speech processor. This context granularity can change based on the types of context information monitored or received. In one variation, context sources register with the context source interface 208 and provide a minimum interval at which the context source will provide new context information. In some cases, even if the context information changes, as long as the context information stays within a range of values, the decision engine can consider the context information as ‘unchanged.’ For example, if network latency remains under 70 ms, then the actual value of the network latency does not matter, and the decision engine can consider the network latency as ‘unchanged.’ If the network latency reaches or exceeds 70 ms, then the decision engine can consider that context information ‘changed.’

Some types of speech requests may depend heavily on availability of a current version of a specific speech model, such as processing a speech search query for current events in a news app on a smartphone. The decision engine 212 can consider that the remote speech processor has a more recent version of the speech model than is available on-device. That factor can be weighted to guide the speech request to the remote speech processor.

The decision engine can consider different pre-selected groups of related context factors for different tasks. For example, the decision engine can use a pre-determined mix of context factors for analyzing content of dialog, a different mix of context factors for analyzing performance of the local speech processor, a different mix of content factors for analyzing performance of the remote speech processor, and a yet a different mix of content factors for analyzing the user's understanding.

In one variation, the system can use partial recognition results of a local or embedded speech recognizer to determine when audio should be redirected to a remote speech processor. The system can benefit from the local grammar built as a hierarchical language model (HLM) that can incorporate, for example, “carrier phrases” and “content” sub-models although a hierarchically structured language model is not necessary for this approach. For example, an HLM with a top level language model (“LM”) can cover multiple tasks, such as “[search for|take a note|what time is it].” The “search for” path in the top level can invoke a web search sub-language model (sub-LM), while the “take a note” path in the top level LM can lead to a transcription sub-LM. Conversely, in this example, the “what time is it” phrase does not require a large sub-LM for completion. Typically, such carrier phrase top-level LMs represent the command and control portion of users' spoken input, and can be of relatively modest size and complexity, while the “content” sub-LMs (in this example, web search and transcription) are relatively larger and more complex LMs. Large sub-LMs can demand too much memory, disk space, battery life and/or computation power to easily run on a typical mobile device.

This variation includes a component that makes a decision whether to forward speech processing tasks to a remote speech processor based on the carrier phrase with the highest confidence or on the partial result of a general language model. If the carrier phrase with the highest confidence or partial result is best completed by a remote speech processor with a larger LM, then the system can forward the speech processing task to that remote speech processor. If the highest-confidence carrier phrase can be completed with LMs or grammars that are local to the device, then the device performs the speech processing task with the local speech processor and does not forward the speech processing task. The system can forward, with the speech processing task, information such as an identifier for a mandatory or suggested sub-LM for processing the speech processing task. When forwarding a speech processing task to a remote speech processor, the system can also forward the text of the highest-confidence carrier phrase, or the partial result of the recognition, and the offset within the speech where the carrier phrase or partial result started/ended. The remote speech processor can use the text of the phrase as a feature in determining the optimal complete ASR result. The remote speech processor can optionally process only the non-carrier-phrase portion of the speech processing task rather than repeating ASR on the entire phrase. Some variations and enhancements to this basic approach are provided below.

In one variation, a local sub-LM includes reduced versions of the corresponding remote full LM. The local sub-LM can include the most common words and phrases, but sufficiently reduced in size and complexity to fit within the constraints of the local device. In this case, if the local speech processor returns a complete result with sufficiently high confidence, the application can return a response and not wait for a result to be returned from the remote speech processor. In another variation, a local sub-LM can include a “garbage’ model loop that “absorbs” the speech following the carrier phrase. In this case, the local speech processor cannot provide a complete result, and so the device can send the speech processing task to the remote speech processor for completion.

The system can relay a speech processing task to the remote speech processor with one or more related or necessary pieces of information, such as the full audio of the speech to be processed, the carrier phrase start and end offsets within the speech. The remote speech processor can then process only the non-carrier-phrase portion of the speech rather than repeating ASR on the entire phrase, for example. In another variation, the system can relay the speech processing task and include only the audio that comes after the carrier phrase, so less data is transmitted to the remote speech processor. The system can indicate, in the transmission, which command is being requested in the speech processing task so that the remote speech processor can apply the appropriate LM to the task.

The local speech processor can submit multiple candidate carrier phrases as well as their respective scores so that the remote speech processor performs the speech processing task using multiple sub-LMs. In some cases, the remote speech processor can receive the carrier phrase text and perform a full ASR on the entire utterance. The carrier phrase results from the remote speech processor may be different from the results generated by the local speech processor. In this case, the results from the remote speech processor can override the results from the local speech processor.

If the local speech processor detects, with high confidence, items such as names present in the contacts list or local calendar appointments, the local speech processor can tag those high confidence items appropriately when sending the speech to the remote speech processor, assisting the remote speech processor in recognizing this information, and avoiding losing the information in the sub-LM process. The remote speech processor may skip processing those portions indicated as having high confidence from the local speech processor.

The carrier phrase top-level LM can be implemented in more than one language. For example, a mobile device sold in England may include a full set of English LMs, but with carrier phrase LMs in other European languages, such as German and French. For languages other than the “primary” language, or English in this example, one or more of the other sub-LMs can be minimal or garbage loops. When the speech processing task traverses a secondary language's carrier phrase LM at the local speech processor, the system can forward the recognition request to the remote speech processor. Further, when the system encounters more than a threshold amount of speech in a foreign language, the system can download a more complete set of LMs for that language.

The system can make the determination of whether and where to perform the speech processing task after the start of ASR, for example, rather than simply relying on factors to determine where to perform the speech processing task before the task begins. This introduces the notion of triggers that can cause the system to make a decision between the local speech processor and the remote speech processor. The system can consider a very different set of factors when making the decision before performing the speech processing task as opposed to after beginning to perform the speech processing task locally. Triggers after beginning speech processing may include, for example, one or more of a periodic time increment (for example, every one second), delivery of partial results from ASR, delivery of audio for one or more new words from TTS, and change in network strength greater than a predefined threshold. For example, if during a recognition the network strength drops below a threshold, the same algorithm can be re-evaluated to determine if the task originally assigned to the remote speech processor should be restarted locally. The system can monitor the confidence score, rather than the partial results, of the local speech processor. If the confidence score, integrated in some manner over time, goes below a threshold, the system can trigger a reevaluation decision to compare the local speech processor with the remote speech processor based on various factors, updates to those factors, as well as the confidence score.

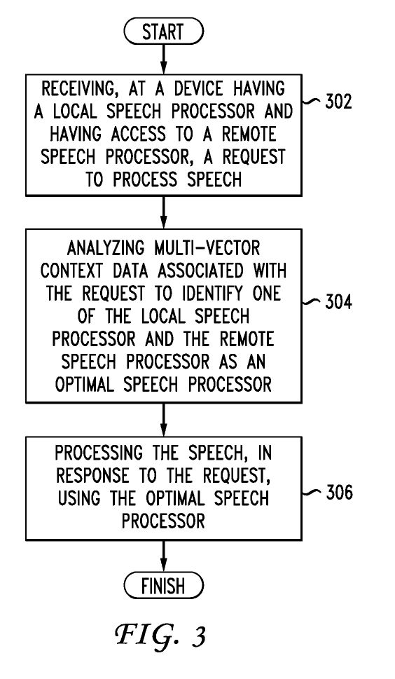

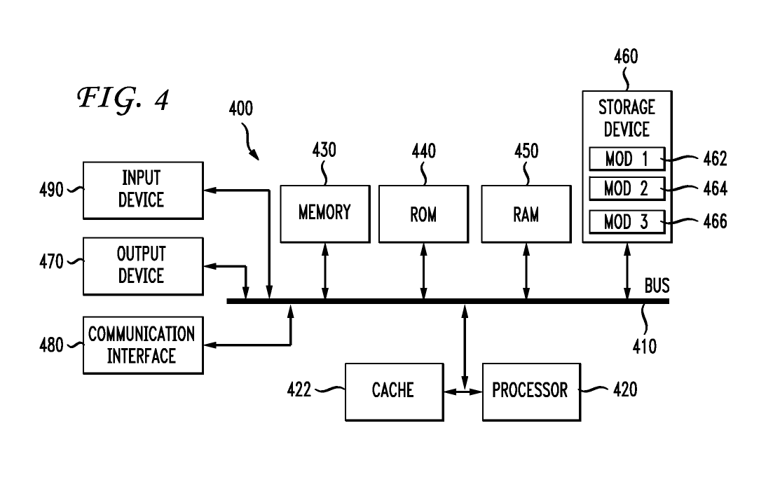

Having disclosed some basic system components and concepts, the disclosure now turns to the exemplary method embodiment shown in FIG. 3. For the sake of clarity, the method is described in terms of an exemplary system 400 as shown in FIG. 4 or local device 102 as shown in FIG. 1 configured to practice the method. The steps outlined herein are exemplary and can be implemented in any combination thereof, including combinations that exclude, add, or modify certain steps.

FIG. 3 illustrates an example method embodiment for routing speech processing tasks based on multiple factors. An example local device configured to practice the method, having a local speech processor, and having access to a remote speech processor, receives a request to process speech (302). Each of the local speech processor and the remote speech processor can be a speech recognizer, a text-to-speech synthesizer, a natural language understanding unit, a machine translation unit, or a dialog manager, for example.

The local device can analyze multi-vector context data associated with the request to identify one of the local speech processor and the remote speech processor as an optimal speech processor (304). The multi-vector context data can include wireless network signal strength, task domain, grammar size, dialogue context, recent network latencies, recent error rates of the local speech processor, language model being used, security level for the request, a privacy level for the request, available speech processor versions, available speech or grammar models, the text and/or the confidence scores form the partial results of an in process speech recognition, and so forth. An intermediate layer, located between a requestor and the remote speech processor, can intercept the request to process speech and analyze the multi-vector context data.

The local device can analyze the multi-vector context data based on a set of rules and/or machine learning. In addition to rules, if the local device identifies a speech processing preference associated with the request, when the optimal speech recognizer conflicts with the speech processing preference, the device can select a different recognizer as the optimal speech recognizer. The local device can refresh the multi-vector context data in response to receiving the request to process speech, and it can refresh the context and reevaluate the decision periodically during a local or remote speech recognition, on a regular time interval or when partial results are emitted by the local recognizer.

Then the local device can process the speech, in response to the request, using the optimal speech processor (306). If the optimal speech processor is local, then the local device processes the speech. If the optimal speech processor is remote, the local device passes the request and any supporting data to the remote speech processor and waits for a result.

Various embodiments of the disclosure are described in detail below. While specific implementations are described, it should be understood that this is done for illustration purposes only. Other components and configurations may be used without parting from the spirit and scope of the disclosure. A brief description of a basic general purpose system or computing device in FIG. 4 which can be employed to practice the concepts, methods, and techniques disclosed is illustrated.

An exemplary system and/or computing device 400 includes a processing unit (CPU or processor) 420 and a system bus 410 that couples various system components including the system memory 430 such as read only memory (ROM) 440 and random access memory (RAM) 450 to the processor 420. The system 400 can include a cache 422 of high speed memory connected directly with, in close proximity to, or integrated as part of the processor 420. The system 400 copies data from the memory 430 and/or the storage device 460 to the cache 422 for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 4 462, module 2 464, and module 3 466 stored in storage device 460, configured to control the processor 420 as well as a special-purpose processor where software instructions are incorporated into the processor. The processor 420 may be a self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. The system 400 can include other hardware or software modules. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out a particular function. In another aspect, the system can use a processor and computer-readable storage medium to store instructions which, when executed by the processor, cause the processor to perform a method or other specific actions. The basic components and appropriate variations can be modified depending on the type of device, such as whether the device 400 is a small, handheld computing device, a desktop computer, or a computer server.

Although the exemplary embodiment(s) described herein employs the hard disk 460, other types of computer-readable media which can store data that are accessible by a computer, such as magnetic cassettes, flash memory cards, digital versatile disks, cartridges, random access memories (RAMs) 450, read only memory (ROM) 440, a cable or wireless signal containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 420. The functions these blocks represent may be provided through the use of either shared or dedicated hardware, including, but not limited to, hardware capable of executing software and hardware, such as a processor 420, that is purpose-built to operate as an equivalent to software executing on a general purpose processor. For example the functions of one or more processors presented in FIG. 4 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 440 for storing software performing the operations described below, and random access memory (RAM) 450 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 400 shown in FIG. 4 can practice all or part of the recited methods, can be a part of the recited systems, and/or can operate according to instructions in the recited tangible computer-readable storage media. Such logical operations can be implemented as modules configured to control the processor 420 to perform particular functions according to the programming of the module. For example, FIG. 4 illustrates three modules Mod1 462, Mod2 464 and Mod3 466 which are modules configured to control the processor 420. These modules may be stored on the storage device 460 and loaded into RAM 450 or memory 430 at runtime or may be stored in other computer-readable memory locations.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied to embedded speech technologies, such as in-car systems, smartphones, tablets, set-top boxes, in-home automation systems, and so forth. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

We claim:

1. A method comprising:
receiving, at a device having a local speech processor and having access to a remote speech processor, a request to process speech;
analyzing multi-vector context data associated with the request to identify one of the local speech processor and the remote speech processor as an optimal speech processor; and
processing the speech, in response to the request, using the optimal speech processor.

2. The method of claim 1, wherein the multi-vector context data comprises one of wireless network signal strength, task domain, grammar size, dialogue context, recent network latencies, recent error rates of the local speech processor, language model being used, security level for the request, a privacy level for the request, a battery charge level, text of partial automatic speech recognition results, a confidence score of partial automatic speech recognition results, a change in network strength greater than a threshold, or available speech processor versions.

3. The method of claim 1, wherein analyzing the multi-vector context data is based on a set of rules.

4. The method of claim 1, wherein analyzing the multi-vector context data is based on machine learning.

5. The method of claim 1, further comprising:
identifying a speech processing preference associated with the request; and
when the optimal speech recognizer conflicts with the speech processing preference, selecting a different recognizer as the optimal speech recognizer.

6. The method of claim 5, further comprising:
when the optimal speech processor is the local speech processor, tracking textual content of recognized speech from the local speech processor and a certainty score of the local speech processor prior to completion of transcription of the speech; and
when the certainty score is below a threshold or when the textual content requests a certain function, sending the speech that has been partially processed by the local speech processor to the remote speech processor.

7. The method of claim 1, wherein each of the local speech processor and the remote speech processor comprises one of a speech recognizer, a text-to-speech synthesizer, a natural language understanding unit, a machine translation unit, or a dialog manager.

8. The method of claim 1, wherein an intermediate layer, located between a requestor and the remote speech processor, intercepts the request to process speech and analyzes the multi-vector context data.

9. The method of claim 1, further comprising:
refreshing the multi-vector context data in response to receiving the request to process speech.

10. The method of claim 9, further comprising:
receiving a trigger;
based on the trigger, refreshing the multi-vector context data to yield refreshed context data; and
reevaluating which of the local speech processor and the remote speech processor is the optimal speech processor based on the refreshed context data.

11. A system comprising:
a processor; and
a computer-readable storage medium storing instructions which, when executed by the processor, cause the processor to perform a method comprising:
receiving, at a device having a local speech processor and having access to a remote speech processor, a request to process speech;
analyzing multi-vector context data associated with the request to identify one of the local speech processor and the remote speech processor as an optimal speech processor; and
processing the speech, in response to the request, using the optimal speech processor.

12. The system of claim 11, wherein the multi-vector context data comprises one of wireless network signal strength, task domain, grammar size, dialogue context, recent network latencies, recent error rates of the local speech processor, language model being used, security level for the request, a privacy level for the request, a battery charge level, text of partial automatic speech recognition results, a confidence score of partial automatic speech recognition results, a change in network strength greater than a threshold, or available speech processor versions.

13. The system of claim 11, wherein analyzing the multi-vector context data is based on a set of rules.

14. The system of claim 11, wherein analyzing the multi-vector context data is based on machine learning.

15. The system of claim 11, the computer-readable storage medium further stores instructions which result in the method further comprising:
identifying a speech processing preference associated with the request; and
when the optimal speech recognizer conflicts with the speech processing preference, selecting a different recognizer as the optimal speech recognizer.

16. The system of claim 11, wherein each of the local speech processor and the remote speech processor comprises one of a speech recognizer, a text-to-speech synthesizer, a natural language understanding unit, a machine translation unit, or a dialog manager.

17. The system of claim 11, wherein an intermediate layer, located between a requestor and the remote speech processor, intercepts the request to process speech and analyzes the multi-vector context data.

18. A non-transitory computer-readable storage medium storing instructions which, when executed by a computing device, cause the computing device to perform a method comprising:
receiving, at a device having a local speech processor and having access to a remote speech processor, a request to process speech;
analyzing multi-vector context data associated with the request to identify one of the local speech processor and the remote speech processor as an optimal speech processor; and
processing the speech, in response to the request, using the optimal speech processor.

19. The non-transitory computer-readable storage medium of claim 18, wherein the multi-vector context data comprises one of wireless network signal strength, task domain, grammar size, dialogue context, recent network latencies, recent error rates of the local speech processor, language model being used, security level for the request, a privacy level for the request, a battery charge level, text of partial automatic speech recognition results, a confidence score of partial automatic speech recognition results, a change in network strength greater than a threshold, or available speech processor versions.

20. The non-transitory computer-readable storage medium of claim 18, storing additional instructions which result in the method further comprising:
identifying a speech processing preference associated with the request; and
when the optimal speech recognizer conflicts with the speech processing preference, selecting a different recognizer as the optimal speech recognizer.
